(19) United States
(12) Patent Application Publication
(10) Pub. No.: US 2026/0310218 A1
(43) Pub. Date: Oct. 8, 2026

(54) SYSTEMS AND METHODS FOR MANAGING AN AUTONOMOUS MANUFACTURING ROBOT ROUTE

(71) Applicant: GM GLOBAL TECHNOLOGY OPERATIONS LLC, Detroit, MI (US)

(72) Inventors: Upali P. Mudalige, Rochester Hills, MI (US); Alireza Esna Ashari Esfahani, San Bruno, CA (US)

(73) Assignee: GM GLOBAL TECHNOLOGY OPERATIONS LLC, Detroit, MI (US)

(21) Appl. No.: 19/172,472

(22) Filed: Apr. 7, 2025

(51) Int. Cl. G05D 1/644

(52) U.S. Cl. CPC G05D 1/644

(57) ABSTRACT

A facility route configuration includes a plurality of facility routing cells. Each facility routing cell defines a position within the route configuration. A valid maneuver attribute defines valid maneuver directions to adjacent facility routing cells. A first autonomous manufacturing robot (AMR) route is defined by a first plurality of AMR routing cells. Each AMR routing cell is associated with a route attribute including a route maneuver direction. The route maneuver direction is at least one of the valid maneuver directions of the associated facility routing cell. Sensor data is received from an AMR in an AMR routing cell. The valid maneuver attribute associated with a facility routing cell is modified based on the sensor data. The first AMR route is modified to generate a second AMR route defined by a second plurality of AMR routing cells based on the first AMR route and the modified valid maneuver attribute.

### INTRODUCTION

The technical field generally relates to autonomous manufacturing robots (AMRs), and more particularly relates to systems and methods for managing an autonomous manufacturing robot (AMR) route.

Manufacturing facilities and warehouse facilities rely on static grid-based routes to generate static AMR routes of AMRs in the facility. The static AMR routes are unable to dynamically adapt operate in accordance with obstacles, signs, a vocal commands, and operator command gestures that the AMR may encounter on the static AMR route.

Accordingly, it is desirable to provide improved methods and systems for managing an autonomous manufacturing robot (AMR) route. Other desirable features and characteristics will become apparent from the subsequent detailed description and the appended claims, taken in conjunction with the accompanying drawings and the foregoing technical field and background.

### SUMMARY

A method of managing an autonomous manufacturing robot (AMR) route includes: receiving a route configuration for a facility including a plurality of facility routing cells, wherein each of the facility routing cells is associated with a position within the route configuration and a valid maneuver attribute defining at least one valid maneuver direction to an adjacent facility routing cell, the at least one valid maneuver direction including at least one of a forward direction, a backward direction, a left direction, and a right direction; receiving a first AMR route of an AMR defined by a first plurality of AMR routing cells, wherein the first plurality of AMR routing cells is a first subset of the plurality of facility routing cells and each of the first plurality of AMR routing cells is associated with a route attribute including a route maneuver direction, the route maneuver direction being one of the at least one valid maneuver direction of the associated facility routing cell; receiving sensor data from an AMR sensor system of an AMR disposed in a first AMR routing cell of the first plurality of AMR routing cells of the first AMR route; modifying the valid maneuver attribute associated with a first facility routing cell of the plurality of facility routing cells based on the sensor data to one of delete one of the at least one valid maneuver direction and add one of the forward direction, the backward direction, the left direction, and the right direction as one of the at least one valid maneuver direction; and modifying the first AMR route to generate a second AMR route defined by a second plurality of AMR routing cells based on the first AMR route and the modified valid maneuver attribute associated with the first facility routing cell, wherein the second plurality of AMR routing cells is a subset of the plurality of facility routing cells.

In at least one embodiment, the method further includes: extracting navigation cue data from the sensor data; generating a navigation cue based on the navigation cue data; and modifying the valid maneuver attribute associated with the first facility routing cell based on the navigation cue.

In at least one embodiment, the method further includes employing a foundation model to generate the navigation cue based on the navigation cue data.

In at least one embodiment, the navigation cue data includes at least one of optical character recognition (OCR) data, object recognition data, quick response (QR) bar code data, facility floor marking data, depth detection data, gesture data, and vocal command data.

In at least one embodiment, the navigation cue includes at least one of a presence of an obstacle, a voice command, a gesture, a sign, and a gated off area.

In at least one embodiment, the method further includes: issuing commands to at least one AMR actuator of the AMR to operate the AMR in accordance with the second AMR route.

In at least one embodiment, a second facility routing cell of the plurality of facility routing cells is associated with a movement attribute defining movement guidelines in a facility area corresponding to the second facility routing cell; and the method further includes modifying the movement attribute associated with the second facility routing cell based on the sensor data.

In at least one embodiment, the method further includes: extracting navigation cue data from the sensor data; employing a foundation model to generate a navigation cue based on the navigation cue data; modifying the movement attribute associated with the second facility routing cell based on navigation cue; modifying a movement guideline of a route attribute associated with a first AMR routing cell corresponding to the second facility routing cell; and issuing commands to at least one AMR actuator of the AMR to operate the AMR in accordance with the modified movement guideline.

An autonomous manufacturing robot (AMR) route management system includes at least one processor and at least one memory communicatively coupled to the at least one processor. The at least one memory includes instructions that upon execution by the at least one processor, cause the at least one processor to: receive a route configuration for a facility including a plurality of facility routing cells, wherein each of the facility routing cells is associated with a position within the route configuration and a valid maneuver attribute defining at least one valid maneuver direction to an adjacent facility routing cell, the at least one valid maneuver direction including at least one of a forward direction, a backward direction, a left direction, and a right direction; receive a first AMR route of an AMR defined by a first plurality of AMR routing cells, wherein the first plurality of AMR routing cells is a first subset of the plurality of facility routing cells and each of the first plurality of AMR routing cells is associated with a route attribute including a route maneuver direction, the route maneuver direction being one of the at least one valid maneuver direction of the associated facility routing cell; receive sensor data from an AMR sensor system of an AMR disposed in a first AMR routing cell of the first plurality of AMR routing cells of the first AMR route; modify the valid maneuver attribute associated with a first facility routing cell of the plurality of facility routing cells based on the sensor data; and modify the first AMR route to generate a second AMR route defined by a second plurality of AMR routing cells based on the first AMR route and the modified valid maneuver attribute associated with the first facility routing cell, wherein the second plurality of AMR routing cells is a subset of the plurality of facility routing cells.

In at least one embodiment, the at least one memory includes further instructions that upon execution by the at least one processor, cause the at least one processor to: extract navigation cue data from the sensor data; generate a navigation cue based on the navigation cue data; and modify the valid maneuver attribute associated with the first facility routing cell based on the navigation cue.

In at least one embodiment, the at least one memory includes further instructions that upon execution by the at least one processor, cause the at least one processor to employ a foundation model to generate the navigation cue based on the navigation cue data.

In at least one embodiment, the navigation cue data includes at least one of optical character recognition (OCR) data, object recognition data, quick response (QR) bar code data, facility floor marking data, depth detection data, gesture data, and vocal command data.

In at least one embodiment, the navigation cue includes at least one of a presence of an obstacle, a voice command, a gesture, a sign, and a gated off area.

In at least one embodiment, the at least one memory includes further instructions that upon execution by the at least one processor, cause the at least one processor to issue commands to at least one AMR actuator of the AMR to operate the AMR in accordance with the second AMR route.

In at least one embodiment, a second facility routing cell of the plurality of facility routing cells is associated with a movement attribute defining movement guidelines in a facility area corresponding to the second facility routing cell; and the at least one memory includes further instructions that upon execution by the at least one processor, cause the at least one processor to modify the movement attribute associated with the second facility routing cell based on the sensor data.

In at least one embodiment, the at least one memory includes further instructions that upon execution by the at least one processor, cause the at least one processor to: extract navigation cue data from the sensor data; employ a foundation model to generate a navigation cue based on the navigation cue data; modify the movement attribute associated with the second facility routing cell based on navigation cue; modify a movement guideline of a route attribute associated with a first AMR routing cell corresponding to the second facility routing cell; and issue commands to at least one AMR actuator of the AMR to operate the AMR in accordance with the modified movement guideline.

A vehicle manufacturing plant including an autonomous manufacturing robot (AMR) route management system includes at least one processor and at least one memory communicatively coupled to the at least one processor. The at least one memory including instructions that upon execution by the at least one processor, cause the at least one processor to: receive a route configuration for a facility including a plurality of facility routing cells, wherein each of the facility routing cells is associated with a position within the route configuration and a valid maneuver attribute defining at least one valid maneuver direction to an adjacent facility routing cell, the at least one valid maneuver direction including at least one of a forward direction, a backward direction, a left direction, and a right direction; receive a first AMR route of an AMR defined by a first plurality of AMR routing cells, wherein the first plurality of AMR routing cells is a first subset of the plurality of facility routing cells and each of the first plurality of AMR routing cells is associated with a route attribute including a route maneuver direction, the route maneuver direction being one of the at least one valid maneuver direction of the associated facility routing cell; receive sensor data from an AMR sensor system of an AMR disposed in a first AMR routing cell of the first plurality of AMR routing cells of the first AMR route; modify the valid maneuver attribute associated with a first facility routing cell of the plurality of facility routing cells based on the sensor data to one of delete one of the at least one valid maneuver direction and add one of the forward direction, the backward direction, the left direction, and the right direction as one of the at least one valid maneuver direction; modify the first AMR route to generate a second AMR route defined by a second plurality of AMR routing cells based on the first AMR route and the modified valid maneuver attribute associated with the first facility routing cell, wherein the second plurality of AMR routing cells is a subset of the plurality of facility routing cells; and issue commands to at least one AMR actuator of the AMR to operate the AMR in accordance with the second AMR route.

In at least one embodiment, the at least one memory includes further instructions that upon execution by the at least one processor, cause the at least one processor to: extract navigation cue data from the sensor data; generate a navigation cue based on the navigation cue data; and modify the valid maneuver attribute associated with the first facility routing cell based on the navigation cue.

In at least one embodiment, the at least one memory includes further instructions that upon execution by the at least one processor, cause the at least one processor to employ a foundation model to generate the navigation cue based on the navigation cue data.

In at least one embodiment, the navigation cue data includes at least one of optical character recognition (OCR) data, object recognition data, quick response (QR) bar code data, facility floor marking data, depth detection data, gesture data, and vocal command data.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of an autonomous manufacturing robot (AMR) route management system in accordance with at least one embodiment;

FIG. 2 is an exemplary portion of a route configuration of a facility in accordance with at least one embodiment;

FIG. 3 is an exemplary portion of a first AMR route of an AMR disposed within the portion of the route configuration of the facility in accordance with at least one embodiment;

FIG. 4 is an exemplary modified AMR route of the AMR disposed within the portion of the route configuration of a facility in accordance with at least one embodiment; and FIG. 5 is a flowchart representation of a method of managing an AMR route in accordance with at least one embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

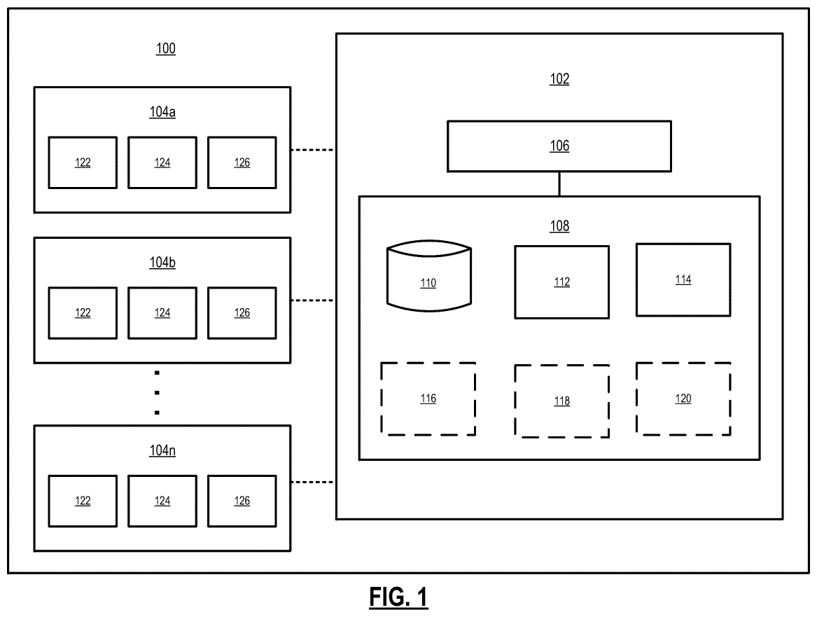

Referring to FIG. 1, a functional block diagram of a facility 100 including an autonomous manufacturing robot (AMR) route management system 102 and a plurality of AMRs 104a, 104b . . . 104n in accordance with at least one embodiment is shown. Examples of the facility 100 include but are not limited to a manufacturing facility and a warehouse facility. An example of a manufacturing facility is a vehicle manufacturing facility. The AMR route management system 102 is configured to be communicatively coupled to the plurality of AMRs 104a, 104b . . . 104n.

In at least one embodiment, the AMR route management system 102 includes at least one processor 106 and a central computation unit 108. The processor(s) 106 is communicatively coupled to the central computation unit 108. The processor(s) 106 is a programable device that includes one or more instructions stored in or associated with the central computation unit 108. The central computation unit 108 includes instructions that the processor(s) 106 is configured to execute.

The central computation unit 108 is a computer readable storage device or media. The central computation unit 108 is at least one memory. The processor(s) 106 can be any custom made or commercially available processor, a central processing unit (CPU), a graphics processing unit (GPU), an auxiliary processor among several processors, a semiconductor-based microprocessor (in the form of a microchip or chip set), a macroprocessor, any combination thereof, or generally any device for executing instructions. The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor(s) 106 is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the AMR route management system 102. The instructions may include one or more separate programs, each of which comprises an ordered listing of executable instructions for implementing logical functions. The instructions, when executed by the processor(s) 106 perform logic, calculations, methods and/or algorithms for implementing the AMR route management system 102.

In at least one embodiment, the central computation unit 108 includes a route configuration database 110 configured to store a route configuration of the facility 100. The route configuration of the facility is a grid-based route configuration defined by a plurality of facility routing cells. The factory routing cells are related to roads in the facility 100 on which the AMRs can navigate. Each facility routing cell is associated with a position within the route configuration of the facility 100. Each facility routing cell is associated with a valid maneuver attribute. The valid maneuver attribute of a facility routing cell defines valid maneuver directions of that facility routing cell with respect to an adjacent facility routing cell in the route configuration. In at least one embodiment, the valid maneuver directions includes one or more of a forward direction, a backward direction, a left direction, and a right direction. In at least one embodiment, the valid maneuver directions includes one or more of a forward direction, a backward direction, a left direction, a right direction, and diagonal movement directions.

In at least one embodiment, one or more of the facility routing cells is associated with a movement attribute. The movement attribute of a facility routing cell defines movement guidelines within that facility routing cell. Example of movement guidelines include, but are not limited to, a speed limit, a yield operation expressed by a yield sign, and a stop operation denoted by stop sign.

The central computation unit 108 includes a central route manager 112. The central route manager 112 is configured to manage the AMR routes of each of the AMRs 104a, 104b . . . 104n in the facility 100. Each AMR route is defined by a plurality of AMR routing cells. The plurality of AMR routing cells is a subset of the facility routing cells. Each AMR routing cell in an AMR route includes a route attribute. Each AMR routing cell is a facility routing cell. The route attribute of an AMR routing cell includes a route maneuver direction. The route maneuver direction of an AMR routing cell is one of the valid maneuver directions defined by the valid maneuver attribute of the associated facility routing cell. The route maneuver direction of an AMR routing cell is aligned with a direction of the AMR route of the AMR 104a, 104b . . . 104n from that AMR routing cell to an adjacent AMR routing cell in the AMR route.

In at least one embodiment, the route attribute of one or more AMR routing cells includes a route movement guideline. The route movement guideline of an AMR routing cell is the movement attribute of the associated facility routing cell.

The central computation unit 108 includes a foundation model 114. In at least one embodiment, the foundation model is a large language model (LLM), a Vision Language model (VLM) or the like. In at least one embodiment, the AMR route management system 102 includes one or more of a navigation cue manager 116, a valid maneuver attribute manager 118, and a movement attribute manager 120.

Each AMR 104a, 104b . . . 104n includes an AMR sensor system 122, a local route manager 124, and one or more AMR actuators 126. The AMR sensor system 122 includes one or more of at least one camera, at least one microphone, and a lidar (light detection and ranging) system.

The local route manager 124 includes at least one processor (not shown) and at least one memory (now shown). The processor(s) is communicatively coupled to the at least one memory. The processor(s) is a programable device that includes one or more instructions stored in or associated with the at least one memory. The at least one memory includes instructions that the processor(s) is configured to execute.

At least one memory is a computer readable storage device or media. The processor(s) can be any custom made or commercially available processor, a central processing unit (CPU), a graphics processing unit (GPU), an auxiliary processor among several processors, a semiconductor-based microprocessor (in the form of a microchip or chip set), a macroprocessor, any combination thereof, or generally any device for executing instructions. The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor(s) is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the local route manager 124. The instructions may include one or more separate programs, each of which comprises an ordered listing of executable instructions for implementing logical functions. The instructions, when executed by the processor(s) 106, perform logic, calculations, methods and/or algorithms for implementing the local route manager 124.

The local route manager 124 of an AMR 104a, 104b . . . 104n includes the AMR route for that AMR 104a, 104b . . . 104n. The local route manager 124 is configured to issue commands to the one or more AMR actuators 126 to implement actions associated with controlling the movement of the AMR 104a, 104b . . . 104n in accordance with the AMR route and the route attributes of the AMR routing cells in the AMR route. In at least one embodiment, the AMR route management system 102 is a distributed system. The local route manager 124 of each AMR 104a, 104b . . . 104n includes one or more of a navigation cue manager 116, a valid maneuver attribute manager 118, and a movement attribute manager 120.

The AMR route management system 102 is configured to be uploaded with the route configuration of the facility and store the uploaded route configuration in the route configuration database 110. The route configuration is defined by a plurality of facility routing cells. Each facility routing cell is associated with a position within the route configuration and a valid maneuver attribute. The valid maneuver attribute defines at least one valid maneuver direction to an adjacent facility routing cell. Examples of valid maneuver directions include a forward direction, a backward direction, a left direction, and a right direction.

A first AMR route is an initial grid that that is designed by offline by a human and defines a the AMR routing cells and the valid maneuvers that are allowed for each AMR routing cell. The AMR route management system 102 is configured to receive the first AMR route of an AMR 104a and store the received first AMR route in the route configuration database 110. The first AMR route is defined by a first plurality of AMR routing cells. Each AMR routing cell in the first AMR route is a facility routing cell. Each AMR routing cell in the first AMR route is associated with a route attribute. The route attribute includes a route maneuver direction. The route maneuver direction of an AMR routing cell is one of the valid maneuver directions defined by the valid maneuver attribute of the associated facility routing cell. The route maneuver direction of the AMR routing cell is aligned with a direction of the AMR route of the AMR 104a from that AMR routing cell to an adjacent AMR routing cell in the first AMR route.

The AMR route management system 102 is configured to receive sensor data from the AMR sensor system 122 of the AMR 104a disposed in a first AMR routing cell of the first AMR route. The AMR route management system 102 is configured to modify the valid maneuver attribute of a first facility routing cell of the plurality of facility routing cells based on the sensor data by either deleting one of the valid maneuver directions or adding one of a forward direction, a backward direction, a left direction, and a right direction as a valid maneuver direction.

The AMR route management system 102 is configured to modify the first AMR route to generate a modified AMR route defined by second plurality of AMR routing cells. The second plurality of AMR routing cells is a subset of the plurality of facility routing cells. The second plurality of AMR routing cells is different from the first plurality of AMR routing cells. The generation of the second AMR route is based on first AMR route and the modified valid maneuver attribute associated with the first facility routing cell.

The AMR route management system 102 may include additional components that facilitate operation of the AMR route management system 102. The AMRs 104a, 104b . . . 104n may include additional components that facilitate operation of the AMRs 104a, 104b . . . 104n. The operation of the AMR route management system 102 in cooperation with the AMRs 104a, 104b . . . 104n will be described in greater detail below.

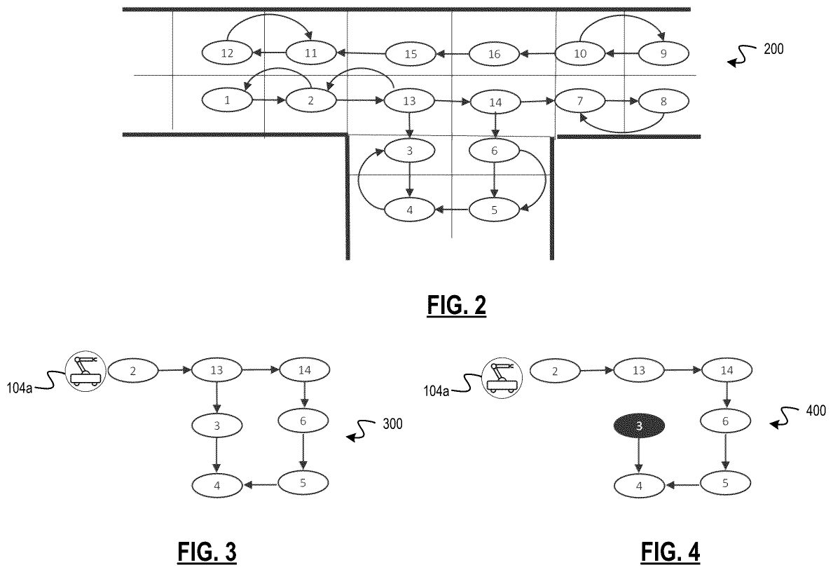

Referring to FIG. 2, an exemplary portion of a route configuration 200 of a facility 100 in accordance with at least one embodiment is shown. The illustrated portion of the route configuration 200 includes sixteen facility routing cells 1-16. Each of the facility routing cells 1-16 is associated with a position within the route configuration 200 and a valid maneuver attribute. The valid maneuver attribute for each facility routing cell 1-16 defines at least one valid maneuver direction from that facility routing cell to an adjacent facility routing cell.

The facility routing cell 1 is associated with a valid maneuver attribute that defines the valid maneuver direction for the facility routing cell 1 as a forward direction. The facility routing cell 2 is associated with a valid maneuver attribute that defines the valid maneuver directions for the facility routing cell 2 as a forward direction and a backward direction. The facility routing cell 3 is associated with a valid maneuver attribute that defines the valid maneuver direction for the facility routing cell 3 as a forward direction. The facility routing cell 4 is associated with a valid maneuver attribute that defines the valid maneuver direction for the facility routing cell 4 as a backward direction. The facility routing cell 5 is associated with a valid maneuver attribute that defines the valid maneuver direction for the facility routing cell 5 as a left direction. The facility routing cell 6 is associated with a valid maneuver attribute that defines the valid maneuver direction for the facility routing cell 6 as a backward direction. The facility routing cell 7 is associated with a valid maneuver attribute that defines the valid maneuver direction for the facility routing cell 7 as a forward direction. The facility routing cell 8 is associated with a valid maneuver attribute that defines the valid maneuver direction for the facility routing cell 8 as a backward direction. The facility routing cell 9 is associated with a valid maneuver attribute that defines the valid maneuver direction for the facility routing cell 9 as a forward direction. The facility routing cell 10 is associated with a valid maneuver attribute that defines the valid maneuver directions for the facility routing cell 10 as a forward direction and backward direction. The facility routing cell 11 is associated with a valid maneuver attribute that defines the valid maneuver direction for the facility routing cell 11 as a forward direction. The facility routing cell 12 is associated with a valid maneuver attribute that defines the valid maneuver direction for the facility routing cell 12 as a backward direction. The facility routing cell 13 is associated with a valid maneuver attribute that defines the valid maneuver directions for the facility routing cell 13 as a right direction and a backward direction. The facility routing cell 14 is associated with a valid maneuver attribute that defines the valid maneuver directions for the facility routing cell 14 as a right direction and a forward direction. The facility routing cell 15 is associated with a valid maneuver attribute that defines the valid maneuver direction for the facility routing cell 15 as a forward direction. The facility routing cell 16 is associated with a valid maneuver attribute that defines the valid maneuver direction for the facility routing cell 16 as a forward direction.

Referring to FIG. 3, an exemplary portion of a first AMR route 300 of an AMR 104a disposed within the portion of the route configuration 200 of the facility 100 in accordance with at least one embodiment is shown. The portion of the illustrated first AMR route 300 includes a first plurality of AMR routing cells 2, 13, 3, 4 that defined the first AMR route. The AMR routing cell 2 corresponds to the facility routing cell 2. The AMR routing cell 13 corresponds to the facility routing cell 13. The AMR routing cell 3 corresponds to the facility routing cell 3. The AMR routing cell 4 corresponds to the facility routing cell 4.

Each of the AMR routing cells 2, 13, 3, 4 is associated with a position within the route configuration 200 and a route attribute. The route attribute for each AMR routing cell 2, 13, 3, 4 defines a route maneuver direction from the AMR routing cell 2, 13, 3, 4 to an adjacent AMR routing cell 2, 13, 3, 4 in accordance with the first AMR route. The route maneuver direction for each AMR routing cell 2, 13, 3, 4 is one of the valid maneuver directions of the associated facility routing cell 2, 13, 3, 4.

The AMR routing cell 2 is associated with a route attribute that defines the route maneuver direction for the AMR routing cell 2 as a forward direction. The AMR routing cell 13 is associated with a route attribute that defines the route maneuver direction for the AMR routing cell 13 as a right direction. The AMR routing cell 3 is associated with a route attribute that defines the route maneuver direction for the AMR routing cell 3 as a forward direction.

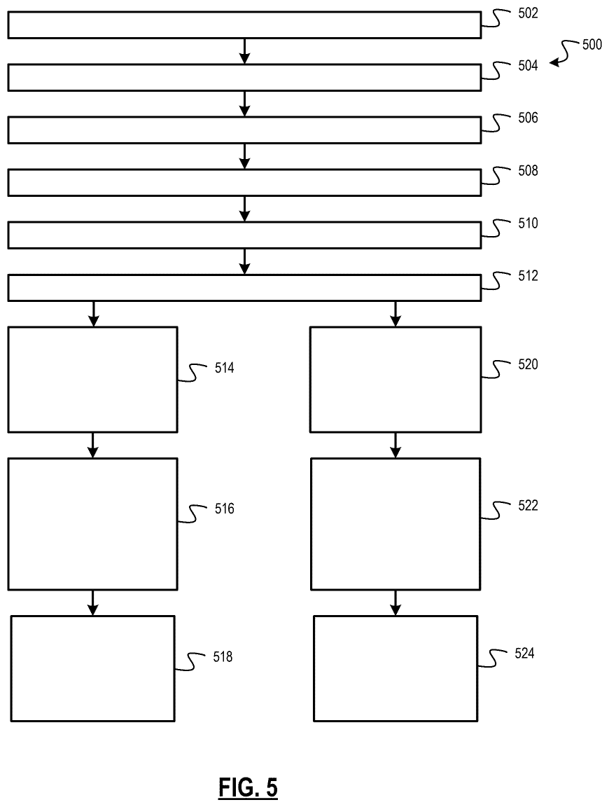

Referring to FIG. 4, an exemplary modified AMR route 400 of the AMR 104a disposed within the portion of the route configuration of a facility 100 in accordance with at least one embodiment is shown.

The AMR route management system 102 received sensor data from an AMR sensor system 122 of the AMR 104a. The sensor data is associated with the facility routing cell 3. The facility routing cell 3 is also the AMR routing cell 3 of the first AMR route 300 of the AMR 104a. The AMR route management system 102 determined that the sensor data indicated a presence of a navigation cue in the facility routing cell 3. The navigation cue may be a temporary navigation cue or a permanent navigation cue. Examples of navigation cues include, but are not limited to, a presence of an obstacle in a position in facility corresponding to the facility routing cell 3, a voice command to not turn right from the position corresponding to AMR routing cell 13 (facility routing cell 13), and a gating off of the position corresponding to AMR routing cell 3 (facility routing cell 3). The presence of the navigation cue in the position of the facility 100 corresponding to the facility routing cell 3 indicates a need to modify the first AMR route to bypass the area of the facility 100 corresponding to the facility routing cell 3.

The AMR route management system 102 modified the valid maneuver attribute of the facility routing cell 13 to delete the right direction (turn right direction) from the valid maneuver directions of the facility routing cell 13 in order to bypass the position in the facility 100 corresponding to the facility routing cell 3. The AMR route management system modified the first AMR route defined by the first plurality of AMR cells 2, 13, 3, 4 of the AMR 104a to generated a modified AMR route defined by a second plurality of AMR cells 2, 13, 14, 6, 5, 4 in response to the presence of the navigation cue and based on the first AMR route 2, 13, 3, 4, the modified valid maneuver attribute associated with the facility routing cell 13, and the valid maneuver attributes of the facility routing cells 2, 14, 6, 5. If the navigational cue, such as for example an operator command, is only related to the ego AMR 104a, the secondary configuration remains local. If the navigational cue, such as for example a newly installed sign, relates to other AMRs 104b . . . 104n, an update with be sent to the processor 106 of the central computing unit and the update will be stored in the route configuration database 110. An example of the update is the removal of a previously valid maneuver from the facility routing cell 13 to facility routing cell 3 as illustrated in FIG. 3.

Referring to FIG. 5, a flowchart representation of a method 500 of managing an AMR route in accordance with at least one embodiment is shown. The method 500 will be described with reference to an exemplary implementation of the AMR route management system 102. As can be appreciated in light of the disclosure, the order of operation within the method 500 is not limited to the sequential execution as illustrated in FIG. 5 but may be performed in one or more varying orders as applicable and in accordance with the present disclosure.

At 502, the AMR route management system 102 receives a route configuration for a facility 100. In at least one embodiment, the central route manager 112 receives the route configuration for the facility 100 and stores the route configuration in the route configuration database 110. The route configuration is defined by a plurality of facility routing cells. Each facility routing cell is associated with a position within the route configuration and a valid maneuver attribute. The valid maneuver attribute defines at least one valid maneuver direction to an adjacent facility routing cell. Examples of valid maneuver directions include a forward direction, a backward direction, a left direction, and a right direction.

One or more of the facility routing cells includes a movement attribute. The movement attribute of a facility routing cell defines movement guidelines in an area of the facility 100 that corresponds to that facility routing cell. Example of movement guidelines include, but are not limited to, a speed limit, a yield sign, and a stop sign.

At 504, the AMR route management system 102 receives an AMR route of an AMR 104a. A first AMR route is an initial grid that that is designed by offline by a human and defines the AMR routing cells and the valid maneuvers that are allowed for each AMR routing cell. In at least one embodiment, the central route manager 112 receives an AMR route of the AMR104a and stores the AMR route of the AMR104a in the route configuration database 110. The AMR route is defined by a first plurality of AMR routing cells. Each AMR routing cell in the AMR route corresponds to a facility routing cell. Each AMR routing cell in the AMR route is associated with a route attribute. The route attribute includes a route maneuver direction. The route maneuver direction of an AMR routing cell is one of the valid maneuver directions defined by the valid maneuver attribute of the corresponding facility routing cell. The route maneuver direction of the AMR routing cell is aligned with a direction of the AMR route of the AMR 104a from that AMR routing cell to an adjacent AMR routing cell in the AMR route.

The route attribute of one or more of the first plurality of AMR routing cells in the AMR route includes a route movement guideline. The route movement guideline of an AMR routing cell in the AMR route of the AMR 104a is the movement attribute of the corresponding facility routing cell. The route configuration database 110 maintains the AMR routes of all of the AMRs 104a, 104b . . . 104n configured to operate in the facility 100.

At 506, the AMR route management system 102 transmits the AMR route to the AMR 104a. In at least one embodiment, the central route manager 112, transmits the AMR route to the AMR 104a.

At 508, the AMR route management system 102 receives sensor data from the AMR sensor system 122. In at least one embodiment, the navigation cue manager 116 receives sensor data from the AMR sensor system 122 of the AMR 104a. The AMR sensor system 122 includes one or more of at least one camera, at least one microphone, and a lidar (light detection and ranging) system. The received sensor data is associated with a location of the facility 100 that corresponds to the AMR routing cell (corresponding to the facility routing cell) that the AMR 104a is disposed in at the time that the sensor data is sensed by the AMR sensor system 122.

At 510, the AMR route management system 102 extracts navigation cue data from the sensor data. In at least one embodiment, the navigation cue manager 116 extracts the navigation cue data from the sensor data. Examples of navigation cue data include, but are not limited to, optical character recognition (OCR) data, object recognition data, quick response (QR) bar code data, facility floor marking data, depth detection data, gesture data, and vocal command data. The navigation cue data corresponds to navigation cues disposed at the location in the facility 100 that corresponds to the AMR routing cell (corresponding to the facility routing cell) that the AMR 104a is disposed in at the time that the sensor data was sensed by the AMR sensor system 122.

At 512, the AMR route management system 102 generates a navigation cue based on the navigation cue data. In at least one embodiment, the navigation cue manager 116 generates the navigation cue based on the navigation cue data. In at least one embodiment, the AMR route management system 102 employs a foundation model 114 to generate the navigation cue based on the navigation cue data. In at least one embodiment, the navigation cue manager 116 employes the foundation model 114 to generate the navigation cue based on the navigation cue data. In at least one embodiment, the foundation model 114 is a large language model (LLM) or a Vision Language model (VLM). The foundation model 114 receives the navigation cue data as an input and generates the navigation cue as an output. Examples of navigation cues include, but are not limited to, the implication of a presence of an obstacle, a voice command, a gesture, a sign, and a gated off area for the route configuration. The location of the navigation cue in the facility 100 corresponds to the AMR routing cell (corresponding to the facility routing cell) associated with that location in the facility 100.

At 514, if applicable, the AMR route management system 102 modifies the valid maneuver attribute associated with a facility routing cell impacted by the navigation cue. In at least one embodiment, if applicable the valid maneuver attribute manager 118 modifies the valid maneuver attribute associated with a facility routing cell impacted by the navigation cue. A modification to the valid maneuver attribute involves either deleting one of the valid maneuver directions or adding one of a forward direction, a backward direction, a right direction, and a left direction to the valid maneuver attribute of the facility routing cell. The method 500 proceeds to 516.

At 516, the AMR route management system 102 modifies the AMR route to generate a modified AMR route defined by a second plurality of AMR routing cells based on the AMR route and the modified value maneuver attribute. In at least one embodiment, the central route manager 112 modifies the AMR route to generate the modified AMR route defined by the second plurality of AMR routing cells based on the AMR route and the modified value maneuver attribute and transmits the modified AMR route to the AMR 104a. In at least one embodiment, the local route manager 124 of the AMR 104a modifies the AMR route to generate the modified AMR route defined by the second plurality of AMR routing cells based on the AMR route and the modified value maneuver attribute. The second plurality of AMR routing cells is a subset of the plurality of facility routing cells. The second plurality of AMR routing cells is different from the first plurality oof AMR routing cells.

At 518, the local route manager 124 issues one or more commands to the AMR actuator(s) 126 to operate the AMR 104a in accordance with the modified AMR route.

At 520, if applicable, the AMR route management system 102 modifies the movement attribute associated with a facility routing cell impacted by the navigation cue. In at least one embodiment, if applicable the movement attribute manager 120 modifies the movement attribute associated with a facility routing cell impacted by the navigation cue. A modification to the movement attribute may for example be a modification a speed limit in the area of the facility 100 associated with the facility routing cell impacted by the navigation cue.

At 522, the AMR route management system 102 modifies the movement guideline of the route attribute associated with the AMR routing cell corresponding to the facility routing cell impacted by the navigation cue. In at least one embodiment, the movement attribute manager 120 modifies the movement guideline of the route attribute associated with the AMR routing cell corresponding to the facility routing cell impacted by the navigation cue. In at least one embodiment, the local route manager 124 modifies the movement guideline of the route attribute associated with the AMR routing cell corresponding to the facility routing cell impacted by the navigation cue.

At 524, the local route manager 124 issues one or more commands to the AMR actuator(s) 126 to operate the AMR 104a in accordance with the modified movement guideline of the route attribute associated with the AMR routing cell corresponding to the facility routing cell impacted by the navigation cue. If the navigational cue, such as for example an operator command, is only related to the ego AMR 104a, the secondary configuration remains local. If the navigational cue, such as for example a newly installed sign, relates to other AMRs 104b . . . 104n, an update with be sent to the processor 106 of the central computing unit and the update will be stored in the route configuration database 110. An example of the update is the removal of a previously valid maneuver from the facility routing cell 13 to facility routing cell 3 as illustrated in FIG. 3.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method of managing an autonomous manufacturing robot (AMR) route comprising:
receiving a route configuration for a facility comprising a plurality of facility routing cells, wherein each of the facility routing cells is associated with a position within the route configuration and a valid maneuver attribute defining at least one valid maneuver direction to an adjacent facility routing cell, the at least one valid maneuver direction comprising at least one of a forward direction, a backward direction, a left direction, and a right direction;
receiving a first AMR route of an AMR defined by a first plurality of AMR routing cells, wherein the first plurality of AMR routing cells is a first subset of the plurality of facility routing cells and each of the first plurality of AMR routing cells is associated with a route attribute including a route maneuver direction, the route maneuver direction being one of the at least one valid maneuver direction of the associated facility routing cell;
receiving sensor data from an AMR sensor system of an AMR disposed in a first AMR routing cell of the first plurality of AMR routing cells of the first AMR route;
extracting navigation cue data from the sensor data, wherein the navigation cue data comprises optical character recognition (OCR) data, object recognition data, quick response (QR) bar code data, facility floor marking data, depth detection data, gesture data, and vocal command data;
generating navigation cues based on the navigation cue data, wherein the navigation cues comprise presence of an obstacle, a voice command, a gesture, a sign, and a gated off area;
modifying the valid maneuver attribute associated with a first facility routing cell of the plurality of facility routing cells based on the navigation cues to one of delete one of the at least one valid maneuver direction and add one of the forward direction, the backward direction, the left direction, and the right direction as one of the at least one valid maneuver direction;
modifying the first AMR route to generate a second AMR route defined by a second plurality of AMR routing cells based on the first AMR route and the modified valid maneuver attribute associated with the first facility routing cell, wherein the second plurality of AMR routing cells is a subset of the plurality of facility routing cells; and
issuing commands to at least one AMR actuator of the AMR to operate the AMR in accordance with the second AMR route.

2. (canceled)

3. The method of claim 1, further comprising employing a foundation model to generate the navigation cues based on the navigation cue data.

4. (canceled)

5. (canceled)

6. (canceled)

7. The method of claim 1, wherein:
a second facility routing cell of the plurality of facility routing cells is associated with a movement attribute defining movement guidelines in a facility area corresponding to the second facility routing cell; and
the method further comprises modifying the movement attribute associated with the second facility routing cell based on the sensor data.

8. The method of claim 7 further comprising:
extracting the navigation cue data from the sensor data;
employing a foundation model to generate the navigation cues based on the navigation cue data;
modifying the movement attribute associated with the second facility routing cell based on the navigation cues;
modifying a movement guideline of a route attribute associated with a first AMR routing cell corresponding to the second facility routing cell; and
issuing commands to the at least one AMR actuator of the AMR to operate the AMR in accordance with the modified movement guideline.

9. An autonomous manufacturing robot (AMR) route management system comprising:
at least one processor; and
at least one memory communicatively coupled to the at least one processor, the at least one memory comprising instructions that upon execution by the at least one processor, cause the at least one processor to:
receive a route configuration for a facility comprising a plurality of facility routing cells, wherein each of the facility routing cells is associated with a position within the route configuration and a valid maneuver attribute defining at least one valid maneuver direction to an adjacent facility routing cell, the at least one valid maneuver direction comprising at least one of a forward direction, a backward direction, a left direction, and a right direction;
receive a first AMR route of an AMR defined by a first plurality of AMR routing cells, wherein the first plurality of AMR routing cells is a first subset of the plurality of facility routing cells and each of the first plurality of AMR routing cells is associated with a route attribute including a route maneuver direction, the route maneuver direction being one of the at least one valid maneuver direction of the associated facility routing cell;
receive sensor data from an AMR sensor system of an AMR disposed in a first AMR routing cell of the first plurality of AMR routing cells of the first AMR route;
extract navigation cue data from the sensor data, wherein the navigation cue data comprises optical character recognition (OCR) data, object recognition data, quick response (QR) bar code data, facility floor marking data, depth detection data, gesture data, and vocal command data;
generate navigation cues based on the navigation cue data, wherein the navigation cues comprise presence of an obstacle, a voice command, a gesture, a sign, and a gated off area;
modify the valid maneuver attribute associated with a first facility routing cell of the plurality of facility routing cells based on navigational cues to one of delete one of the at least one valid maneuver direction and add one of the forward direction, the backward direction, the left direction, and the right direction as one of the at least one valid maneuver direction;
modify the first AMR route to generate a second AMR route defined by a second plurality of AMR routing cells based on the first AMR route and the modified valid maneuver attribute associated with the first facility routing cell, wherein the second plurality of AMR routing cells is a subset of the plurality of facility routing cells; and
issue commands to at least one AMR actuator of the AMR to operate the AMR in accordance with the second AMR route.

10. (canceled)

11. The system of claim 9, wherein the at least one memory comprises further instructions that upon execution by the at least one processor, cause the at least one processor to employ a foundation model to generate the navigation cues based on the navigation cue data.

12. (canceled)

13. (canceled)

14. (canceled)

15. The system of claim 9, wherein:
a second facility routing cell of the plurality of facility routing cells is associated with a movement attribute defining movement guidelines in a facility area corresponding to the second facility routing cell; and
the at least one memory comprises further instructions that upon execution by the at least one processor, cause the at least one processor to modify the movement attribute associated with the second facility routing cell based on the sensor data.

16. The system of claim 15, wherein the at least one memory comprises further instructions that upon execution by the at least one processor, cause the at least one processor to:
employ a foundation model to generate the navigation cues based on the navigation cue data;
modify the movement attribute associated with the second facility routing cell based on the navigation cues;
modify a movement guideline of a route attribute associated with a first AMR routing cell corresponding to the second facility routing cell; and
issue commands to the at least one AMR actuator of the AMR to operate the AMR in accordance with the modified movement guideline.

17. A vehicle manufacturing plant including an autonomous manufacturing robot (AMR) route management system comprising:
at least one processor; and
at least one memory communicatively coupled to the at least one processor, the at least one memory comprising instructions that upon execution by the at least one processor, cause the at least one processor to:
receive a route configuration for a facility comprising a plurality of facility routing cells, wherein each of the facility routing cells is associated with a position within the route configuration and a valid maneuver attribute defining at least one valid maneuver direction to an adjacent facility routing cell, the at least one valid maneuver direction comprising at least one of a forward direction, a backward direction, a left direction, and a right direction;
receive a first AMR route of an AMR defined by a first plurality of AMR routing cells, wherein the first plurality of AMR routing cells is a first subset of the plurality of facility routing cells and each of the first plurality of AMR routing cells is associated with a route attribute including a route maneuver direction, the route maneuver direction being one of the at least one valid maneuver direction of the associated facility routing cell;
receive sensor data from an AMR sensor system of an AMR disposed in a first AMR routing cell of the first plurality of AMR routing cells of the first AMR route;
extract navigation cue data from the sensor data, wherein the navigation cue data comprises optical character recognition (OCR) data, object recognition data, quick response (QR) bar code data, facility floor marking data, depth detection data, gesture data, and vocal command data;
generate navigation cues based on the navigation cue data, wherein the navigation cues comprise presence of an obstacle, a voice command, a gesture, a sign, and a gated off area;
modify the valid maneuver attribute associated with a first facility routing cell of the plurality of facility routing cells based on the navigational cues to one of delete one of the at least one valid maneuver direction and add one of the forward direction, the backward direction, the left direction, and the right direction as one of the at least one valid maneuver direction;
modify the first AMR route to generate a second AMR route defined by a second plurality of AMR routing cells based on the first AMR route and the modified valid maneuver attribute associated with the first facility routing cell, wherein the second plurality of AMR routing cells is a subset of the plurality of facility routing cells; and
issue commands to at least one AMR actuator of the AMR to operate the AMR in accordance with the second AMR route.

18. (canceled)

19. The vehicle manufacturing plant of claim 17, wherein the at least one memory comprises further instructions that upon execution by the at least one processor, cause the at least one processor to employ a foundation model to generate the navigation cues based on the navigation cue data.

20. (canceled)

21. The vehicle manufacturing plant of claim 19, wherein the foundation model comprises a large language model (LLM)

22. The vehicle manufacturing plant of claim 19, wherein the foundation model comprises a Vision Language model (VLM).

23. The vehicle manufacturing plant of claim 17, wherein:
a second facility routing cell of the plurality of facility routing cells is associated with a movement attribute defining movement guidelines in a facility area corresponding to the second facility routing cell; and
the at least one memory comprises further instructions that upon execution by the at least one processor, cause the at least one processor to modify the movement attribute associated with the second facility routing cell based on the sensor data.

24. The vehicle manufacturing plant of claim 23, wherein the at least one memory comprises further instructions that upon execution by the at least one processor, cause the at least one processor to:
employ a foundation model to generate the navigation cues based on the navigation cue data;
modify the movement attribute associated with the second facility routing cell based on the navigation cues;
modify a movement guideline of a route attribute associated with a first AMR routing cell corresponding to the second facility routing cell; and
issue commands to the at least one AMR actuator of the AMR to operate the AMR in accordance with the modified movement guideline.

25. The vehicle manufacturing plant of claim 23, wherein the movement guidelines comprises a speed limit.

26. The vehicle manufacturing plant of claim 23, wherein the movement guidelines comprises a yield operation.

27. The vehicle manufacturing plant of claim 23, wherein the movement guidelines comprises a stop operation.

28. The vehicle manufacturing plant of claim 17, wherein the AMR sensor system comprises a camera and a microphone.

29. The vehicle manufacturing plant of claim 17, wherein the AMR sensor system comprises a lidar system.

30. The vehicle manufacturing plant of claim 17, wherein a first AMR route is designed offline by a human.
